(19) United States
(12) Patent Application Publication
(10) Pub. No.: US 2005/0252787 A1
(43) Pub. Date: Nov. 17, 2005

(54) Method for the production of a porous material with a periodic pore arrangement

(76) Inventors: Ralf Wehrspohn, Halle (DE); Ulrich M. Gosele, Halle (DE); Kornelius Nielsch, Berlin (DE); Jinsub Choi, Halle (DE); Manfred Reiche, Halle (DE); Marin Alexe, Halle (DE)

Correspondence Address: SIERRA PATENT GROUP, LTD., P O BOX 6149, STATELINE, NV, 89449, US

(21) Appl. No.: 10/506,037

(22) PCT Filed: Feb. 5, 2003
(86) PCT No.: PCT/EP03/01138

§ 371 Date: May 23, 2005

(30) Foreign Application Priority Data
Feb. 25, 2002 (DE) 102 07 952.8

(51) Int. Cl. B23H 3/00

(52) U.S. Cl. 205/661

(57) ABSTRACT

The invention relates to a method for producing highly ordered pore structures in porous aluminium oxide using a nano-imprint stamp and also to a method for the manufacturing of the stamp and to the stamp itself.

The invention relates to a method for the production of porous material, in particular of porous aluminium oxide with a periodic arrangement of pores using a stamp, and also a method for the manufacture of the stamp.

In the area of nano-technology the development tends towards increasingly fine structures with increasingly smaller and well defined dimensions which lie in the submicron range. A special area of nano-technology is concerned with regular arrangements of holes or tubes in a substrate with at least substantially identical hole dimensions lying in the submicron range. Such highly ordered two- or three-dimensional structures find applications, for example, in optical components, for example photonic crystals, high-density magnetic storage media, but also in structures which are required for the template synthesis of mono-disperse nano-rods or nano-tubes. These can be used in optical, electronic, chemical or biological fields. Further applications include the field of fine filters.

Customary structuring methods for the manufacture of submicron structures, for example highly ordered pore arrangements, are based on photolithography or ion beam lithography and plasma-chemical structuring.

Another possibility for the manufacture of highly ordered pore arrangements is based on the electro-chemical etching of aluminium. It has been known for a long time that porous aluminium oxide structures with hole diameters in the submicron range arise under certain conditions during the anodization of aluminium. In the year 1995, Hideki Masuda of the Tokyo University, Japan, observed that under certain conditions self-ordering pore structures can be achieved. Typical average pore spacings thereby amount to 50, 65, 110 or 500 nm.

So-called nano-embossing processes, also termed nano-imprint processes or nano-indentation processes, are also known which are used for the generation of submicron structures in polymer films and which are, for example, used in the photolithographic structure transfer to a substrate (U.S. Pat. No. 5,772,905).

Similar nano-imprint processes can also assist an intentional formation of porous aluminium oxide. The U.S. Pat. No. 6,139,713 describes for example the process of direct embossing of recesses into the surface of an aluminium substrate with the aid of a stamp and the subsequent formation of tube-like pores in the aluminium oxide by electrochemical etching of the aluminium substrate, with the pores having a spacing which, in accordance with the statement of the document, is identical to the spacing of the recesses produced by the stamp in the aluminium substrate.

In addition a series of further publications describes the manufacture of ordered porous aluminium oxide structures using the nano-imprint technique (H. Masuda et al., Appl. Phys. Let. 71, 2770 (1997); S. W. Pang et al., J. Vac. Sci. Techn. B16, 1145 (1998); H. Masuda et al., Jap. J. Appl. Phys. 38, L1403 (1999); H. Masuda et al., Jap. J. Appl. Phys. 39, L1039 (2000); H. Asoh et al., J. Vac. Sci. Technol. B19, 569 (2001)). Although hexagonally arranged pore structures in aluminium oxide are described in the majority of the publications other arrangement such as for example square arrangements or graphite lattice arrangements can be produced with the aid of the nano-imprint technique (H. Masuda et al., Adv. Mater. 13, 189 (2001)).

Furthermore, H. Masuda describes that by omitting individual imprints in the surface of the aluminium substrate, i.e. with a conscious generation of lattice defects pores nevertheless grow at the defects. Through this “self-repairing effect” lattice defects in a regular array, for example non-present or failed impressions of the stamp, are self-healed (H. Masuda et al., Appl. Phys. Lett. 78, 826 (2001)).

A method for the generation of a hexagonal nano-imprint in the surface of an aluminium substrate is also known in which a stamp is used having a stamp surface which is provided with elongate strip-like projections extending parallel to one another. The stamp is pressed for the first time onto the surface of the aluminium substrate and then, after a rotation through 60 degrees with respect to the aluminium substrate, is pressed onto the surface a second time. In this manner hexagonally arranged imprints are produced at positions where the linear imprints of the stamp intersect in the surface of the aluminium substrate and serve as the starting points for ordered pore growth in subsequently formed aluminium oxide. Through the double stamp process and the rotation of the stamp a hexagonally arranged pore structure can consequently be produced with a periodicity which is smaller than the periodicity of the linear grid structure on the stamp surface.

The invention is based on the object of providing a simple method for the production of porous material with a periodic pore arrangement with the periodicity being dissimilar to the imprints produced by means of a stamp in a material layer. Furthermore, it is the object of the invention to make available a method for the simple and cost-favourable manufacturing of the stamp.

In order to satisfy the first object a method with the features of claim 1 is provided in accordance with the invention.

This is a method for the generation of porous material with a periodic pore arrangement in which starting points are produced in the surface region of the material layer with the aid of a stamp, the stamp having a stamp surface which is provided at least regionally with periodically arranged projections with an average point spacing (D_{Keim}) and the surface region of the material layer is exposed to an electro-chemical etching solution and an electrical potential in such a way that, in dependence on the arrangement of the starting points and on the selected potential, a self-organizing regular pore structure having an average pore spacing (D_{Por}) forms which is different from the average point spacing (Dₖₑᵢₘ).

The method of the invention is particularly well suited to producing a porous aluminium oxide layer on the aluminium substrate in which the regular pore structure, in particular a periodic arrangement of tube-like pores, is formed with a high aspect ratio. In accordance with the invention an average pore spacing can be achieved this which is either larger or smaller than the average starting point spacing.

In particular it is possible in this way to produce pore arrangements with an average pore spacing which is smaller than the average starting point spacing in a simple manner, i.e. smaller than the average spacing of the projections on the stamp surface of the stamp. Thus, finer pore arrangements can be produced than would be possible with a 1:1 transfer of the stamp structure to the material layer, the minimum periodicity of which is restricted by the lithographic process used for the manufacture of the stamp.

An average pore spacing (D_{Por′}) is advantageously set by the potential which is smaller than the average starting point spacing (D_{Keim}), with additional pores disposed between the starting points being formed by a self-organization process.

The potential is preferably set such that a pore forms at each starting point and in addition a pore is formed in each case in the centre of a triangle formed by three adjacent starting points.

The potential is preferably set such that the ratio D_{Por}/D_{Keim} amounts to approximately 0.6. With this potential setting, i.e. this ratio of the average pore spacing D_{Por} to the average starting point spacing D_{Keim}, the self-organizing effect proves to be particularly effective. Above all, it is possible in this manner to produce particularly good “interstitial” pores during the formation of porous aluminium oxide.

In order to satisfy the second object a method with the features of claim 11 is provided in accordance with the invention.

This is a method for the production of a stamp, for example for use in the above-explained method, in which a first three-dimensional structure is produced in a surface region of an auxiliary substrate, thereafter a hard material layer is applied at least to the surface region of the auxiliary substrate having the first structure in such a way that a second structure is formed at the surface of the hard material layer bordering on the auxiliary substrate which is inverse to the first structure, thereafter the surface of the hard material layer pointing away from the auxiliary substrate is connected to a carrier substrate and thereafter the auxiliary substrate is separated from the hard material layer.

The method of the invention enables a manufacture of large area stamps and is moreover fully VLSI-compatible, i.e. can be carried out with customary processes used in semiconductor technology.

By first producing a first three-dimensional structure in an auxiliary substrate and then transferring this as an inverse structure to the hard material layer, which is finally held by the carrier substrate, suitable materials for the auxiliary substrate, for the hard material layer and for the carrier substrate can be selected separately from one another depending on the particular application. Thus, a material can be selected for the auxiliary substrate, independently the hard material layer and the material layer from which the porous material is to be formed, with the material for the auxiliary substrate being optimized solely with respect to the generation of the first three-dimensional structure. For example, a mono-crystalline silicon wafer can be used as the auxiliary substrate in which inverted pyramids can be etched in a simple manner.

In contrast, the hard material layer, which preferably has a non-metallic material, can be adapted directly to the material layer in which the starting points for the periodic pore arrangement of the porous material are to be produced. If, for example, the production of porous aluminium oxide from an aluminium layer is desired, then a hard material layer of Si₃N₄, SiN, SiC, SiO₂ or C with a hardness which is greater than that of the aluminium proves to be particularly advantageous in order to produce imprints in the aluminium layer.

As a result of the strength of the hard material layer the starting points can be produced by a direct impression of the stamp onto the material layer, so that it is possible to dispense with additional method steps in which, for example with the aid of the stamp, first of all a photo resist layer covering the material layer is perforated and the starting points are subsequently formed in the material layer through the holes of the photo resist layer, for example by means of ion beam etching.

In order not to break under a suitable contact pressure, the half material layer is held by a carrier substrate. The carrier substrate can be selected in this connection solely with respect to its stability characteristics in order to achieve a uniform pressure distribution on the hard material layer and thus on the material layer to be imprinted.

The carrier substrate, which is preferably formed of a crystal material, in particular of silicon, is preferably connected by means of adhesive or bonding to the hard material layer.

An intermediate layer, in particular a layer of spin-on-glass, is advantageously arranged between the hard material layer and the carrier substrate. The layer of spin-on-glass can easily be applied to the hard material layer where, as a buffer layer, it evens the surface of the hard material layer facing the carrier substrate and forms a particularly good adhesive undercoat for the connection to the carrier substrate.

A further subject of the invention is a stamp for use or when used in the above explained method for the production of porous material with a periodic pore arrangement and manufactured with the aid of the above explained manufacturing method, the stamp having at least one carrier substrate on which at least one hard material layer, in particular a non-metallic hard material layer, is arranged which has projections, at least regionally, at its surface facing away from the substrate.

The projections are advantageously periodically arranged, with the periodicity preferably lying in the submicron range and in particular in the range of a few 10 nm to a few 100 nm. With such an arrangement of projections, particularly highly ordered regular pore structures can be produced.

The projections are preferably pyramids. Such pyramidic projections can be manufactured in a particularly simple manner in that inverted pyramids are produced as a first three-dimensional structure in the auxiliary substrate during the manufacture of the stamp and can easily be etched for example in a mono-crystalline silicon wafer.

Through the pointed form of the projections the contact pressure of the stamp required to produce the starting points in the material layer can be reduced by a factor of 50 in comparison to customary stamps (H. Masuda et al., Jpn. J. Appl. Phys. 38, L140 (1999); S. Pang et al., J. Vac. Sci. Technol. B16, 1145 (1998)), which leads to reduced requirements for the pressing device and, on the other hand, to reduced danger of breakage, i.e. to an increased working life of the stamp.

In the following the invention will be described purely by way of example and with reference to the accompanying drawing. There are shown:

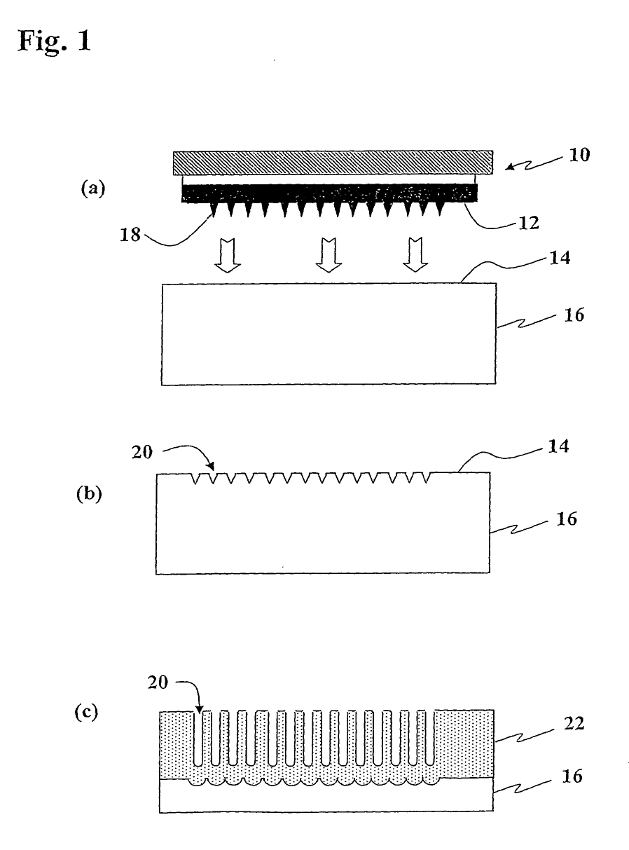

FIGS. 1a-c a schematic representation of different steps of the method of the invention for the production of porous material with a periodic pore arrangement;

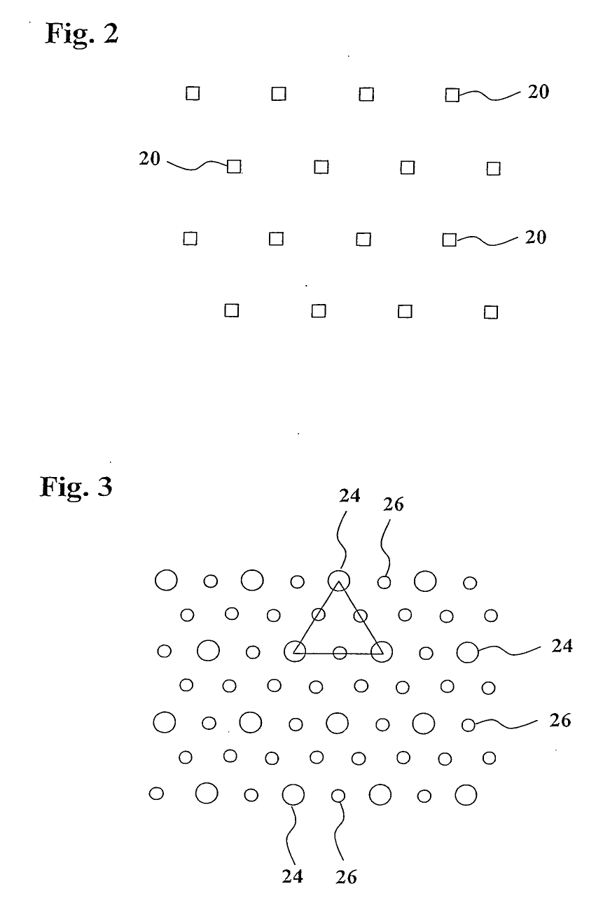

FIG. 2 a schematic representation of an imprint of a stamp in accordance with the invention in an aluminium layer;

FIG. 3 a schematic representation of the pore arrangement in the porous aluminium oxide at the surface of the aluminium oxide layer with D_{Por}=0.5=D_{Keim};

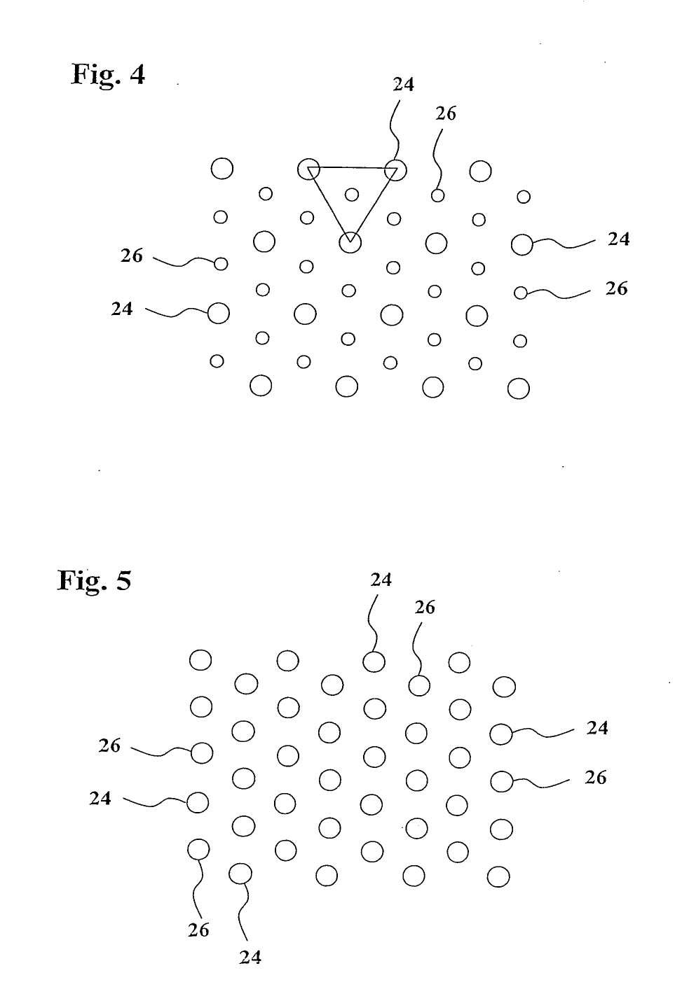

FIG. 4 a schematic representation of the pore arrangement in the porous aluminium oxide at the surface of the aluminium oxide layer with D_{Por}=0.6 D_{Keim};

FIG. 5 a schematic representation of the pore arrangement in FIG. 4 in a region of the aluminium oxide layer remote from the surface;

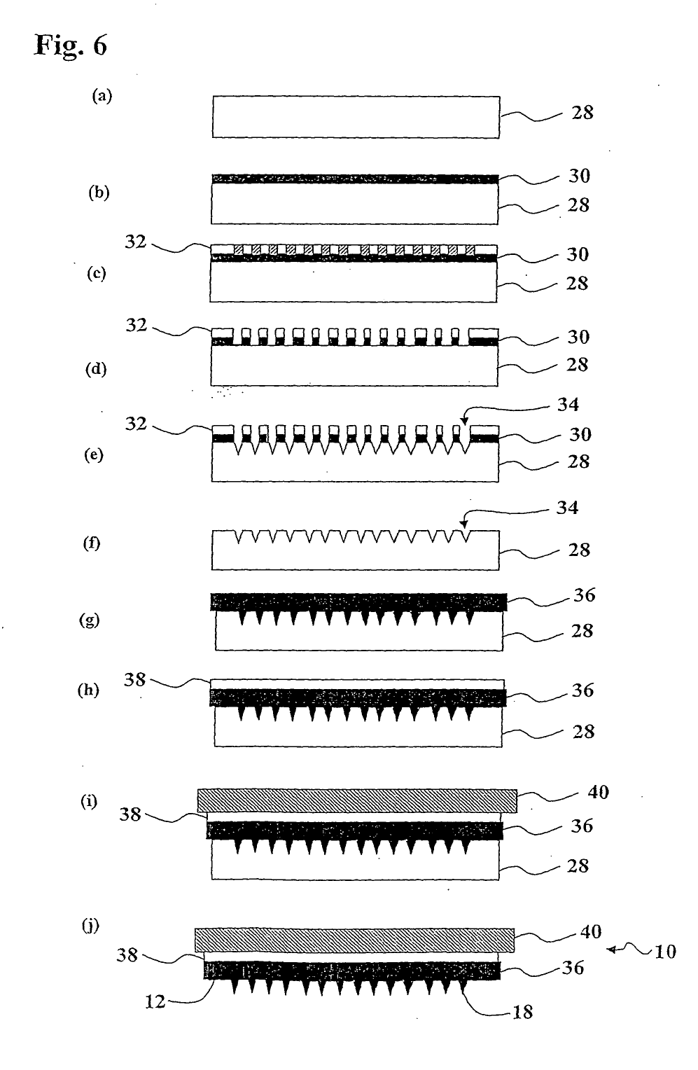

FIGS. 6a-j a schematic representation of various steps of the method of the invention for the manufacture of a stamp to produce the imprints shown in FIG. 2;

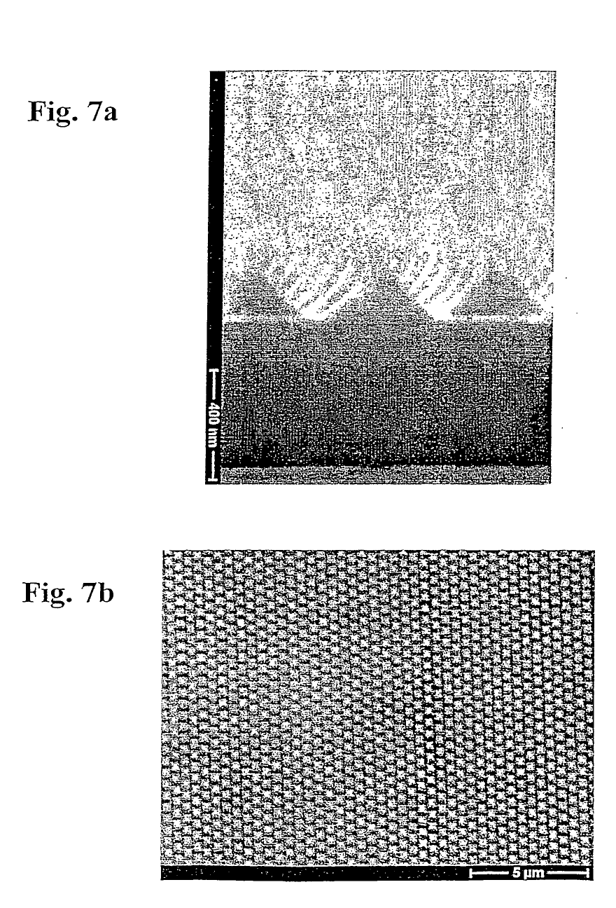

FIGS. 7a, b raster electron microscope recordings of the stamp surface of a stamp in accordance with the invention in a perspective view (a) and a plan view (b);

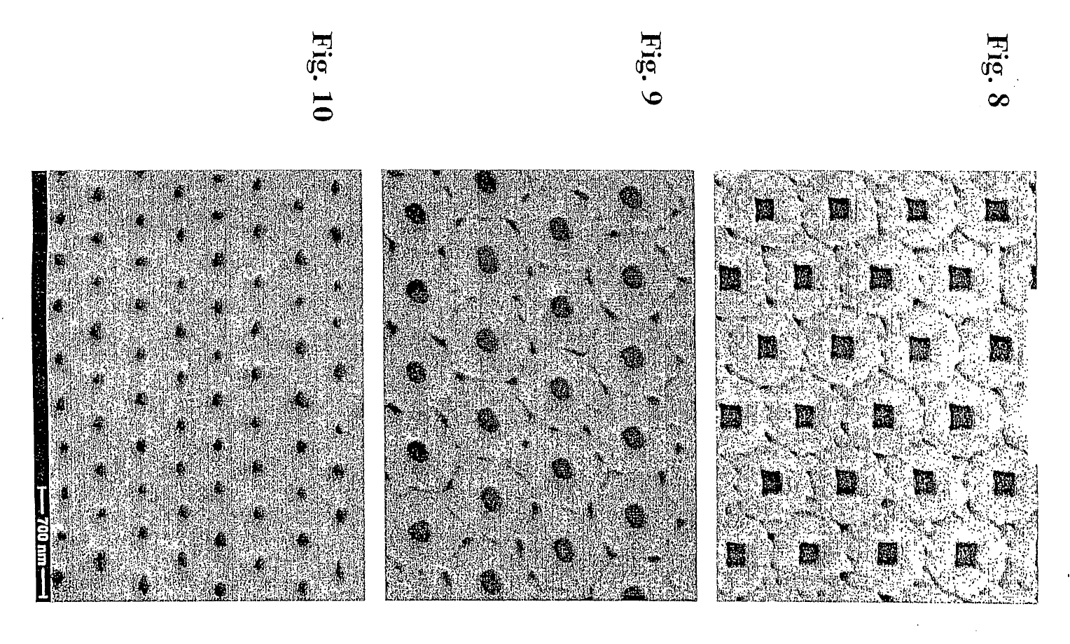

FIG. 8 a REM recording of the pore arrangement in FIG. 3;

FIG. 9 a REM recording of the pore arrangement in FIG. 4;

FIG. 10 a REM recording of the pore arrangement in FIG. 5; and

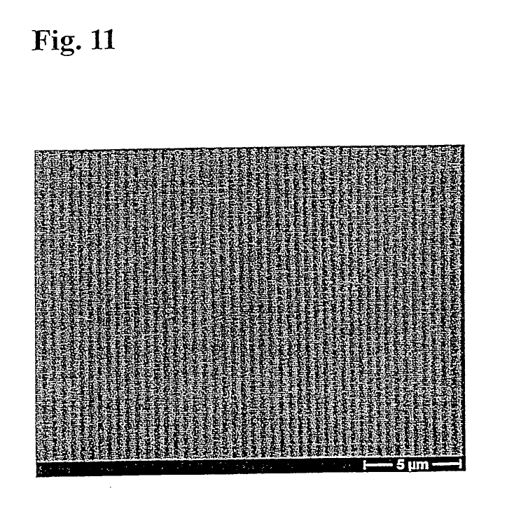

FIG. 11 a REM recording of the pore arrangement in FIGS. 4 and 5 seen in the longitudinal section of the tubular pores.

First of all, the method of the invention for the production of porous material with a periodic pore arrangement will be explained with reference to FIG. 1. In this connection the formation of highly ordered porous aluminium oxide or an aluminium layer will be described by way of example. It is, however, likewise conceivable to use the method for other metallic materials such as for example titanium, niobium or tantalum or for semiconductor materials.

In a first step of the method of the invention which can be seen in FIG. 1a a stamp surface 12 of a stamp 10, of which the layout and manufacture will be described in more detail further below, is pressed onto the surface 14 of an aluminium layer 16. A three-dimensional structure is formed on the stamp surface 12 which has periodically arranged projections 18.

In the embodiment described here the projections 18 are hexagonally arranged, they can however also form a square grid or a graphite grid. Furthermore the projections 18 in the example described here are formed as pointed pyramids, although variants of the invention can also be formed as pyramids with rounded tips, as truncated pyramids, as cylinders, cones, cones with rounded cone tips or made spherical. The hexagonally arranged pyramidic projections 18 have an average spacing which is termed here the starting point spacing D_{Keim}, for a reason which come clear further below and which typically lies in the submicron range, preferably in the range of a few 10 nm to a few 1000 nm. The height of the projections 18 lies in a similar range.

By pressing the stamp 10 against the surface 14 of the aluminium layer 16 the three-dimensional structure of the stamp surface 12 is transferred inversely to the surface 14 of the aluminium layer as shown in FIG. 1b, i.e. recesses 20 are produced in the surface 14 of the aluminium layer 16 by the pyramids 18, with the two-dimensional arrangement of the recesses 20 corresponding to the arrangement of the projections 18 and in this case being hexagonal (see FIG. 2). The depth of the recesses 20 depends on the size of the contact pressure. A depth of a few 10 nm can, for example, be achieved by a contact pressure of a few kN/cm².

Subsequently the structured surface 14 of the aluminium layer 16 is exposed to an electrochemical etching solution, for example a sulphuric acid, oxalic acid or phosphoric acid solution and a potential U and is anodized, whereby, as can be seen in FIG. 1c, porous aluminium oxide 22 forms on the surface 14 of the aluminium layer 16. The size of the pores which form thereby depends on the pH value of the electrochemical etching solution, whereas the average pore spacing D_{Por} is proportional to the applied potential U, with the proportionality factor amounting to 2.5 nm/V.

During the production of the porous aluminium oxide 22 the recesses 20 in the surface 14 of the aluminium layer 16 act as starting points for the tubular pores 24 which form perpendicular to the surface 14. Insofar as the applied potential U is selected such that the value of the potential corresponds, in accordance with the above named proportionality, directly to the starting point spacing D_{Keim}, i.e. amounts to the average spacing of the recesses 20 divided by 2.5 nm/V the tubular pores 24 arise at every lattice location of the hexagonal lattice, i.e. always there where a recess 20 is located.

In accordance with the invention provision is however made to achieve a pore spacing D_{Por} which is not the same as the starting point spacing D_{Keim} but rather larger or smaller than the starting spacing D_{Keim}. This is achieved in that a potential U is selected which does not correspond to D_{Keim}/x nm/V with x=2.5 but rather to a value x different from 2.5 and with the self-organization characteristic of the pore grid being exploited.

If the voltage U is set such that x=5, then, as shown in FIG. 3, in addition to the pores 24 produced at the lattice sites of the hexagonal lattice through the self-organization characteristics of the periodic pore arrangement, additional pores 26 form in each case between two adjacent pores so that D_{Por}=0.5 D_{Keim}.

The self-organization effect of the periodic pore grid can be particularly well exploited when the potential is selected such that the equation

$${D}_{Por} / {D}_{Keim} = \sqrt{\frac{13}{6}} \approx 0 , 6$$

applies for the ratio of the pore spacing to the starting point spacing. In this case, an additional interstitial pore 26 is produced in each case at the centre of a triangle formed by three adjacent pores 24 which have grown at the starting points 20.

By exploiting the self-organization effect it is, however, not only possible to produce pore spacings D_{Por} which are smaller than the average starting point spacing D_{Keim} but rather also pore spacings D_{Por} which are larger than the average starting point spacing D_{Keim}. In this case a potential must be set which is correspondingly larger than the potential which would lead to the pore spacing D_{Por}=D_{Keim}. Excess starting points, i.e. recesses 20 of which too many have been produced are reduced or healed by the self-organization of the pore arrangement. A particularly suitable ratio of average pore spacing to average starting point spacing is in this respect D_{Por}/D_{Keim}=1.66.

In the determination of the average pore spacings by the setting of a suitable anodization potential approximately the following applies, that the potential U at D_{Por}=D_{Keim} to the potential U at D_{Por}≠D_{Keim} is the same as the ratio of the average pore spacing at D_{Por}=D_{Keim} to the average pore spacing at D_{Por}≠D_{Keim}, i.e.
U(D_{Por}=D_{Keim})/U(D_{Por}≠D_{Keim})=D_{Por}(D_{Por}32 D_{Keim})/D_{Por}(D_{Por}≠D_{Keim}),
wherein a deviation from this ratio up to ±8% is possible.

In FIGS. 3 and 4 the arrangement and the size of both the tubular pores 24 and also of the additional interstitial pores 26 at the surface of the aluminium oxide 22 is shown. It can be seen that the additional pores 26 at the surface of the aluminium layer 22 have a smaller diameter than those at the starting points 20, i.e. at the pores 24 produced at the points of the hexagonal grid.

As can be seen from FIG. 5 the diameter of the interstitial pores 26 however equates from a certain depth of the surface of the aluminium oxide layer 22 onwards to the diameter of the pores 24 produced at the starting points 20, so that the regular pores and the interstitial pores 24, 26 are identically formed from a certain depth below the surface and are no longer to be distinguished from one another.

The result is thus a hexagonal arrangement of tubular pores 24, 26, the periodicity of which is considerably smaller than that of the structure transferred by the stamp 10. The average pore spacing D_{Por} amounts to approximately three fifths of the average point spacing D_{Keim} (D_{Por}≈0.6 D_{Keim}).

Through the removal of a surface near region of the porous aluminium oxide layer 22 and the aluminium layer 16 an aluminium oxide layer 22 can be produced which has a highly ordered periodically pore structure which includes at least substantially identical tubes 24, 26.

In FIG. 6 there are shown the important steps of the method of the invention for the manufacture of a stamp in accordance with the invention. The starting material is in this embodiment a mono-crystalline (100) orientated silicon wafer serving as an auxiliary substrate, for example with a diameter of 4 inches (FIG. 6a). Silicon is a wide spread material in semiconductor technology the handling of which is adequately well known with methods and processes for its processing known from the area of microchip manufacture being able to be used. For this reason, and for a further reason which will be apparent immediately, the mono-crystalline silicon wafer proves to be a very favorably auxiliary substrate. However, auxiliary substrates of other semiconductor materials or indeed of metallic materials are basically conceivable.

After a cleaning treatment, the Si auxiliary substrate 28 is first provided with a silicon dioxide layer 30, for example by means of a thermal oxidation process (FIG. 6b). The oxide layer 30 is then covered with a photo resist layer 32 which is, for example, provided with a hexagonally arranged hole structure, for example by means of a suitable mask and corresponding exposure, with a grid constant of for example 500 nm and a hole diameter of 300 nm, for example by lithography with deep UV (248 nm) (FIG. 6c). After the development of the photo resist 32 the exposed structure is, for example, transferred into the SiO₂ layer 30 (FIG. 6d), for example by etching in hydrofluoric acid.

Thereafter inverted pyramids 34 are anisotropically etched into the Si auxiliary substrate 28, for example in KOH through the open photo resist layer 32 and the oxide layer 30. In this connection the use of the (100)-silicon substrate 28 proves to be particularly advantageous because a preferential etching along the specific crystal directions can be achieved by a suitable concentration of the KOH solution and it can thus be anisotropically etched. In this manner very regular inverted pyramidic structures can be produced (FIG. 6e).

After the formation of the inverted pyramids 34 the photo resist layer 32 is dissolved in acetone and the SiO₂-layer 30 is removed from the Si auxiliary substrate 28 in hydrofluoric acid and the silicon wafer 28 is cleaned (FIG. 6f).

Thereafter a non-metallic hard material layer 36 can be applied on the structured surface of the silicon wafer 28 (FIG. 6g). The hard material layer 36 is preferably a Si₃N₄-layer of a few hundred nanometers thickness which is, for example, formed by means of chemical gas phase deposition. In just the same way however hard material layers 36 of SiN, SiC or C would be conceivable. The surface of hard material layer 36 adapts to the structured surface of the silicon substrate 28, i.e. to the surface of the inverted pyramids 34 so that the hard material layer 36 is provided with a hexagonal arrangement of pyramidic projections 18 at least at its surface facing towards the auxiliary substrate 28.

A layer of spin-on-glass (SOG) is applied (FIG. 6h) to the surface of the Si₃N₄ layer facing away from the auxiliary substrate 28. This SOG layer 38 which acts as a buffer layer serves, on the one hand, to even out the surface of the hard material layer 36 facing away from the substrate 28 and, on the other hand, as a bonding undercoat for an adhesive bond between the hard material layer 36 and a carrier substrate 40 which can, for example, be achieved by a bonding process (FIG. 6i). The carrier substrate 40 preferably likewise includes a silicon substrate and also here the situation applies in which other materials, in particular other semiconductor materials and also metallic materials, can be considered for the carrier substrate 40.

Thereafter the Si auxiliary substrate 28 is removed from the hard material layer 36. This can take place both in a mechanical manner, for example by grinding and/or polishing, by wet chemical etching, by plasma assisted etching or by any desired combination of these removal methods (FIG. 6j).

The result is a stamp 10 in accordance with the invention consisting of a carrier substrate 40, an SOG layer 38 and a hard material layer 36 provided with a periodical array of pyramidic projections 18 which has been manufactured exclusively by VLSI-compatible method steps. As a result of the hard material layer 36 formed from Si₃N₄ the three-dimensional structure of the stamp 10 can be non-destructively transferred onto a comparatively soft aluminium layer 16 so that the stamp 10 can be multiply used, i.e. can be used for numerous stamp processes.

In the following a special embodiment of a stamp 10 in accordance with the invention and also of the periodic pore arrangement produced with it in porous aluminium oxide will be described. As explained above, a (100)-oriented 4″ silicon wafer is structured with a two-dimensional hexagonal grid with a grid constant of 500 nm and a hole diameter of 300 nm by means of low UV lithography (248 nm).

In accordance with the above described process, hexagonally arranged pyramidic projections with a height of 260 nm and a lattice constant of 500 nm are produced in a 300-500 nm thick Si₃N₄ layer by means of the inverted pyramids produced in the silicon substrate.

For the preparation for the formation of porous aluminium oxide layer the surface of an aluminium layer is mechanically polished in order to achieve a particularly smooth surface with a roughness of R_{q}<100 nm prior to the stamp process.

Using a pressure of 5 kN/cm², the hexagonal structure of the stamp is then transferred onto the surface of the aluminium layer, with the rectangular recesses being produced with a depth of proximately 40 nm in the surface of the aluminium layer, which serve as starting points for the formation of the aluminium oxide. Through the use of a stamp surface with pyramidic projections it is possible to select a stamp which is approximately 50 times smaller than is the case with similar known stamp processes (H. Masuda et al., Jpn. J. Appl. Phys. 38, L140 (1999); S. Pang et al., J. Vac. Sci. Technol. B16, 1145 (1998)).

When using a stamp surface with 260 nm high pyramidic projections it is basically possible to produce approximately 260 nm deep imprints in the aluminium layer. In this connection, in the case of pyramidic projections, not only does the depth of the grid imprint increase on increasing the stamp pressure but rather also the lateral dimension of the recesses increases.

The imprinted surface of the aluminium layer is subsequently anodized in oxalic or phosphoric acid. In order to achieve a match of the pore spacing and the starting point spacing the proportionality dependency D_{Por}=2.5 nm/V·U must be fixed at a grid constant of 500 nm at the voltage U of approximately 200 Volts in order to achieve an average pore spacing 500 nm. However, in order to achieve an average pore spacing of 250 nm, the anodization is carried at 100 V (see FIG. 3) or at 120 V, in order to set the average pore spacing to 300 nm (see FIG. 4).

With an anodization potential U of 120 V one succeeds, starting from the starting point grid with the grid constant of 500 nm in 1.7% phosphoric acid, in producing a perfect, highly ordered pore structure with an average pore spacing of 300 nm. From a depth of 3 μm measured from the surface of the aluminium oxide all the pores have the same diameter of 85 nm over a pore length of 80 μm. The pores disposed at the grid sides, i.e. at the starting points, cannot be distinguished from interstitial pores which are each disposed between 3 adjacent “regular” pores.

Consequently it is possible, through the self-organization effect, to produce highly ordered pore structures the grid constants of which are smaller than those of the structure on the stamp surface. This, for example, enables the production of pore structures with a grid constant of 100 nm by means of a stamp with a grid constant of 180 nm or indeed of 40 nm pore structures by means of a stamp with a 60 nm grid constant and indeed by pressing just once with the stamp.

Moreover, it has been found that the cross-section of the tubular pores of the surface of the aluminium oxides depends on the structure shape at the stamp surface and on the stamp pressure. A rectangular cross-section of the pores at the surface of the aluminium oxide can be achieved when the structure transfer takes place by rectangular projections and with a high stamp pressure, whereas one obtains circular pore cross-sections at low stamp pressure.

In contrast thereto the pore cross-section at the base of the pores, i.e. at the boundary surface between the aluminium oxide and the aluminium layer, is principally influenced by the current flow and the electrolyte and not by the shape of the impression in the surface of the aluminium layer. If the rectangular structure is consequently transferred at a high stamp pressure, then one can observe a change of the pore cross-section in the longitudinal direction of the pores starting from a rectangular cross-section at the surface of the aluminium oxide and up to a round cross-section at the base of the tubular pores.

The raster electron microscope recordings of the stamp surface 12 of the stamp 10 with the projections 18 (FIGS. 7a and 7b), of the arrangement of the pores 24, 26 at the surface of the aluminium oxide layer 22 (FIG. 8 and FIG. 9) and also of the pore arrangement at a depth of 3 μm below the surface of the aluminium oxide layer 22 (FIG. 10) and the arrangement and shape of the pores 24, 26 when seen in their longitudinal direction (FIG. 11) serve as prove for the good realizability of the method of the invention and of the stamp of the invention.

### REFERENCE NUMERAL LIST

10 stamp
12 stamp surface
14 surface
16 aluminium layer
18 projection/pyramids
20 recess
22 aluminium oxide
24 pore
26 pore
28 auxiliary substrate
30 oxide layer
32 photo resist layer
34 inverted pyramids
36 hard material layer
38 SOG layer
40 carrier substrate

1-27. (canceled)

28. A method for the production of porous material with a periodic arrangement of pores in which:
starting points are produced in a surface region of a material layer with the aid of a stamp, the stamp having a stamp surface which is provided at least regionally with periodically arranged projections with an average point spacing; and
the surface region of the material layer is exposed to an electrochemical etching solution and an electrical potential in such a way that, in dependence on the arrangement of the starting points and on the selected potential, a self-organizing regular pore structure having an average pore spacing forms which is different from the average point spacing.

29. The method in accordance with claim 28, characterized in that:
aluminum is used as the material and the etching solution is selected such that aluminum oxide forms as the porous material.

30. The method in accordance with claim 28, characterized in that:
a valve metal is used as the material and the etching solution is selected such that a corresponding porous valve metal arises as the porous material.

31. The method in accordance with claim 28, characterized in that:
the stamp for the production of the starting points is brought directly into contact with the surface region of the material layer.

32. The method in accordance with claim 28, characterized in that:
the stamp is pressed onto the surface region of the material layer in such a way that the projections produce recesses in the material layer acting as starting points.

33. The method in accordance with claim 28, characterized in that:
through the potential an average pore spacing is set which is smaller than the average starting point spacing, with additional pores being formed between the starting points through a self-organization process.

34. The method in accordance with claim 28, characterized in that:
the potential is selected such that a pore is formed at each starting point and in addition a pore is formed in each case in the center of a triangle formed by three neighboring starting points.

35. The method in accordance with claim 28, characterized in that:
the potential is selected such that the ratio of the average pore spacing per average point spacing amounts to approximately 0.6.

36. The method in accordance with claim 28, characterized in that:
an average pore spacing larger than the average point spacing is set by the potential, with excess starting points being reduced by a self-organization process.

37. The method in accordance with claim 36, characterized in that:
the potential is set such that the ratio of the average pore spacing/average point spacing amounts to approximately 1.66.

38. A method for the manufacture of a stamp, in which:
a first three-dimensional structure is produced in a surface region of an auxiliary substrate,
thereafter a hard material layer is applied at least to the surface region of the auxiliary substrate having the first structure in such a way that a second structure is formed at the surface of the hard material layer bordering on the auxiliary substrate which is inverse to the first structure,
thereafter the surface of the hard material layer pointing away from the auxiliary substrate is connected to a carrier substrate, and
thereafter the auxiliary substrate is separated from the hard material layer.

39. The manufacturing method in accordance with claim 38, characterized in that:
recesses are produced in the surface region of the auxiliary substrate.

40. The manufacturing method in accordance with claim 38, characterized in that:
inverted pyramids are generated in a surface region of the auxiliary substrate.

41. The manufacturing method in accordance with claim 40, characterized in that:
the inverted pyramids are produced by plasma-assisted etching or wet chemical etching.

42. The manufacturing method in accordance with claim 40, characterized in that:
the inverted pyramids are produced by preferential etching along specific crystal directions in a crystalline auxiliary substrate, in a particular silicon substrate.

43. The manufacturing method in accordance with claim 38, characterized in that:
a hard material layer of a compound selected from the group consisting of Si₃N₄, SiN, SiC, SiO₂, and C is deposited at least on the surface region of the auxiliary substrate having the first structure.

44. The manufacturing method in accordance with claim 43, characterized in that:
the hard material layer is connected to a carrier substrate by means of one from a group selected from adhesive and bonding.

45. The manufacturing method in accordance with claim 43, characterized in that:
an intermediate layer, in particular a layer of spin-on-glass, is arranged between the hard material layer and a carrier substrate.

46. A stamp manufactured by a method in which:
a first three-dimensional structure is produced in a surface region of an auxiliary substrate,
thereafter a hard material layer is applied at least to the surface region of the auxiliary substrate having the first structure in such a way that a second structure is formed at the surface of the hard material layer bordering on the auxiliary substrate which is inverse to the first structure,
thereafter the surface of the hard material layer pointing away from the auxiliary substrate is connected to a carrier substrate, and
thereafter the auxiliary substrate is separated from the hard material layer, the stamp thereby having at least one carrier substrate on which at least one hard material layer is arranged which has projections, at least regionally, at least at its surface facing away from the carrier substrate.

47. The stamp in accordance with claim 46, characterized in that:
the projections are periodically arranged, with the periodicity preferably lying in the submicron range and in particular in the range of a few 10 nm to a few 1000 nm.

48. The stamp in accordance with clam 46, characterized in that:
the projections are hexagonally arranged.

49. The stamp in accordance with claim 46, characterized in that:
the projections are in a square arrangement.

50. The stamp in accordance with claim 46, characterized in that:
the projections are pyramids having a one selected from a group consisting of rounded tips and truncated pyramids.

51. The stamp in accordance with claim 46, characterized in that:
the projections are formed in a shape selected from a group consisting of cylinders, cones, cones with rounded tips and spheres.

52. The stamp in accordance with claim 46, characterized in that:
the hard material layer is formed of a compound selected from the group consisting of Si₃N₄, SiN, SiC, SiO₂, and C.

53. The stamp in accordance with claim 46, characterized in that:
the carrier substrate is formed of a crystal material, in particular of silicon.

54. The stamp in accordance with claim 46, characterized in that:
an intermediate layer, which is in particular formed of spin-on-glass, is arranged between the carrier substrate and the hard material layer.
